(19) United States
(12) Patent Application Publication
(10) Pub. No.: US 2003/0088648 A1
(43) Pub. Date: May 8, 2003

(54) Supporting access control checks in a directory server using a chaining backend method

(76) Inventors: Gilles Bellaton, St. Martin d'Heres (FR); Sylvain Duloutre, Fontaine (FR); Mark C. Smith, Saline, MI (US)

Correspondence Address: ROSENTHAL & OSHA L.L.P., 1221 MCKINNEY AVENUE, SUITE 2800, HOUSTON, TX, 77010, US

(21) Appl. No.: 10/001,939

(22) Filed: Nov. 2, 2001

(51) Int. Cl. G06F 15/16

(52) U.S. Cl. 709/219

(57) ABSTRACT

A method to support access control checks in a directory server with a chaining backend includes binding a user to a multiplexer, forwarding an authentication sequence from the multiplexer to a first remote server, binding the user to the first remote server, authenticating the user if binding to the first remote server is successful, binding the multiplexer as a special user to a second remote server, where the second remote server holds target data, sending an operation and an original user identity from the user to the multiplexer, and forwarding the operation from the multiplexer to the second remote server.

### BACKGROUND OF INVENTION

The most fundamental program resident on any computer is the operating system (OS). Various operating systems exist in the market place, including Solaris™ from Sun Microsystems Inc., Palo Alto, Calif. (Sun Microsystems), MacOS from Apple Computer, Inc., Cupertino, Calif., Windows® 95/98 and Windows NT®, from Microsoft Corporation, Redmond, Wash., UNIX, and Linux. The combination of an OS and its underlying hardware is referred to herein as a “traditional platform”. Prior to the popularity of the Internet, software developers wrote programs specifically designed for individual traditional platforms with a single set of system calls and, later, application programming interfaces (APIs).

Thus, a program written for one platform could not be run on another. However, the advent of the Internet made cross-platform compatibility a necessity and a broader definition of a platform has emerged. Today, the original definition of a traditional platform (OS/hardware) dwells at the lower layers of what is commonly termed a “stack,” referring to the successive layers of software required to operate in the environment presented by the Internet and World Wide Web.

Effective programming at the application level requires the platform concept to be extended all the way up the stack, including all the new elements introduced by the Internet. Such an extension allows application programmers to operate in a stable, consistent environment.

iPlanet™ E-commerce Solutions, a Sun Microsystems|Netscape Alliance, has developed a net-enabling platform shown in FIG. 1 called the Internet Service Deployment Platform (ISDP) (28). ISDP (28) gives businesses a very broad, evolving, and standards-based foundation upon which to build an e-enabled solution.

ISDP (28) incorporates all the elements of the Internet portion of the stack and joins the elements seamlessly with traditional platforms at the lower levels. ISDP (28) sits on top of traditional operating systems (30) and infrastructures (32). This arrangement allows enterprises and service providers to deploy next generation platforms while preserving “legacy-system” investments, such as a mainframe computer or any other computer equipment that is selected to remain in use after new systems are installed.

ISDP (28) includes multiple, integrated layers of software that provide a full set of services supporting application development, e.g., business-to-business exchanges, communications and entertainment vehicles, and retail Web sites. In addition, ISDP (28) is a platform that employs open standards at every level of integration enabling customers to mix and match components. ISDP (28) components are designed to be integrated and optimized to reflect a specific business need. There is no requirement that all solutions within the ISDP (28) are employed, or any one or more is exclusively employed.

In a more detailed review of ISDP (28) shown in FIG. 1, the iPlanet™ deployment platform consists of the several layers. Graphically, the uppermost layer of ISDP (28) starts below the Open Digital Marketplace/Application strata (40).

Below the server strata, a layer called Unified User Management Services (48) is dedicated to issues surrounding management of user populations, including Directory Server (80), Meta-directory (82), delegated administration (84), Public Key Infrastructure (PKI) (86), and other administrative/access policies (88). The Unified User Management Services layer (48) provides a single solution to centrally manage user account information in extranet and e-commerce applications. The core of this layer is iPlanet™ Directory Server (80), a Lightweight Directory Access Protocol (LDAP)-based solution that can handle more than 5,000 queries per second.

iPlanet™ Directory Server (iDS) provides a centralized directory service for an Intranet or extranet while integrating with existing systems. The term directory service refers to a collection of software, hardware, and processes that store information and make the information available to users. The directory service generally includes at least one instance of the iDS and one or more directory client programs. Client programs can access names, phone numbers, addresses, and other data stored in the directory.

The iDS is a general-purpose directory that stores all information in a single, network-accessible repository. The iDS provides a standard protocol and API to access the information contained by the iDS. The iDS provides global directory services, meaning that information is provided to a wide variety of applications. Until recently, many applications came bundled with a proprietary database. While a proprietary database can be convenient if only one application is used, multiple databases become an administrative burden if the databases manage the same information. For example, in a network that supports three different proprietary e-mail systems where each system has a proprietary directory service, if a user changes passwords in one directory, the changes are not automatically replicated in the other directories. Managing multiple instances of the same information results in increased hardware and personnel costs.

The global directory service provides a single, centralized repository of directory information that any application can access. However, giving a wide variety of applications access to the directory requires a network-based means of communicating between the numerous applications and the single directory. The iDS uses LDAP to give applications access to the global directory service.

LDAP is the Internet standard for directory lookups, just as the Simple Mail Transfer Protocol (SMTP) is the Internet standard for delivering e-mail and the Hypertext Transfer Protocol (HTTP) is the Internet standard for delivering documents. Technically, LDAP is defined as an on-the-wire bit protocol (similar to HTTP) that runs over Transmission Control Protocol/Internet Protocol (TCP/IP). LDAP creates a standard way for applications to request and manage directory information.

An LDAP-compliant directory, such as the iDS, leverages a single, master directory that owns all user, group, and access control information. The directory is hierarchical, not relational, and is optimized for reading, reliability, and scalability. This directory becomes the specialized, central repository that contains information about objects and provides user, group, and access control information to all applications on the network. For example, the directory can be used to provide information technology managers with a list of all the hardware and software assets in a widely spanning enterprise. Most importantly, a directory server provides resources that all applications can use, and aids in the integration of these applications that have previously functioned as stand-alone systems. Instead of creating an account for each user in each system the user needs to access, a single directory entry is created for the user in the LDAP directory. FIG. 2 shows a portion of a typical directory with different entries corresponding to real-world objects. The directory depicts an organization entry (90) with the attribute type of domain component (dc), an organizational unit entry (92) with the attribute type of organizational unit (ou), a server application entry (94) with the attribute type of common name (cn), and a person entry (96) with the attribute type of user ID (uid). All entries are connected by the directory.

Understanding how LDAP works starts with a discussion of an LDAP protocol. The LDAP protocol is a message-oriented protocol. The client constructs an LDAP message containing a request and sends the message to the server. The server processes the request and sends a result, or results, back to the client as a series of LDAP messages. Referring to FIG. 3, when an LDAP client (100) searches the directory for a specific entry, the client (100) constructs an LDAP search request message and sends the message to the LDAP server (102) (step 104). The LDAP server (102) retrieves the entry from the database and sends the entry to the client (100) in an LDAP message (step 106). A result code is also returned to the client (100) in a separate LDAP message (step 108).

LDAP-compliant directory servers like the iDS have nine basic protocol operations, which can be divided into three categories. The first category is interrogation operations, which include search and compare operators. These interrogation operations allow questions to be asked of the directory. The LDAP search operation is used to search the directory for entries and retrieve individual directory entries. No separate LDAP read operation exists. The second category is update operations, which include add, delete, modify, and modify distinguished name (DN), i.e., rename, operators. A DN is a unique, unambiguous name of an entry in LDAP. These update operations allow the update of information in the directory. The third category is authentication and control operations, which include bind, unbind, and abandon operators.

The bind operator allows a client to identify itself to the directory by providing an identity and authentication credentials. The DN and a set of credentials are sent by the client to the directory. The server checks whether the credentials are correct for the given DN and, if the credentials are correct, notes that the client is authenticated as long as the connection remains open or until the client re-authenticates. The unbind operation allows a client to terminate a session. When the client issues an unbind operation, the server discards any authentication information associated with the client connection, terminates any outstanding LDAP operations, and disconnects from the client, thus closing the TCP connection. The abandon operation allows a client to indicate that the result of an operation previously submitted is no longer of interest. Upon receiving an abandon request, the server terminates processing of the operation that corresponds to the message ID.

In addition to the three main groups of operations, the LDAP protocol defines a framework for adding new operations to the protocol via LDAP extended operations. Extended operations allow the protocol to be extended in an orderly manner to meet new marketplace needs as they emerge.

The basic unit of information in the LDAP directory is an entry, a collection of information about an object. Entries are composed of a set of attributes, each of which describes one particular trait of an object. Attributes are composed of an attribute type (e.g., common name (cn), surname (sn), etc.) and one or more values. FIG. 4 shows an exemplary entry (124) showing attribute types (120) and values (122). Attributes may have constraints that limit the type and length of data placed in attribute values (122). A directory schema places restrictions on the attribute types (120) that must be, or are allowed to be, contained in the entry (124).

iPlanet™ Directory Server (iDS) is a type of application directory that delivers user-management infrastructure for managing large volumes of user information for e-business applications and services. The iDS provides global directory services by providing information to a wide variety of applications. Until recently, many applications came bundled with their own proprietary databases. However, as discussed above, while a proprietary database can be convenient for a one application environment, multiple databases become an administrative burden if they manage the same information.

The global directory service provides a single, centralized repository of directory information that any application can access. However, giving a wide variety of applications access to the directory requires a network-based means of communicating between the applications and the directory. The iDS uses LDAP to give applications access to the global directory service.

### SUMMARY OF INVENTION

In general, in one aspect, the invention involves a method to support access to control checks in a directory server. The method comprises binding a user to a multiplexer, forwarding an authentication sequence from the multiplexer to a first remote server, binding the user to the first remote server, authenticating the user if binding to the first remote server is successful, binding the multiplexer as a special user to a second remote server, wherein the second remote server holds target data, sending an operation and an original user identity from the user to the multiplexer, and forwarding the operation from the multiplexer to the second remote server.

In general, in one aspect, the invention involves a computer system to support access to control checks in a directory server with a chaining backend. The computer system comprises a processor and a memory. Software instructions stored in the memory for enabling the computer system under control of the processor to perform binding a user to a multiplexer, forwarding an authentication sequence from the multiplexer to a first remote server, binding the user to the first remote server, authenticating the user if binding to the first remote server is successful, binding the multiplexer as a special user to a second remote server, wherein the second remote server holds target data, sending an operation and an original user identity from the user to the multiplexer, and forwarding the operation from the multiplexer to the second remote server.

In general, in one aspect, the invention involves an apparatus to support access control checks in a directory server with a chaining backend. The apparatus comprises means for binding a user to a multiplexer, means for forwarding an authentication sequence from the multiplexer to a first remote server, means for binding the user to the first remote server, means for authenticating the user if binding to the first remote server is successful, means for binding the multiplexer as a special user to a second remote server, wherein the second remote server holds target data, means for sending an operation and an original user identity from the user to the multiplexer, and means for forwarding the operation from the multiplexer to the second remote server.

Other aspects and advantages of the invention will be apparent from the following description and the appended claims.

### BRIEF DESCRIPTION OF DRAWINGS

FIG. 1 illustrates a block diagram of iPlane™ Internet Service Development Platform.

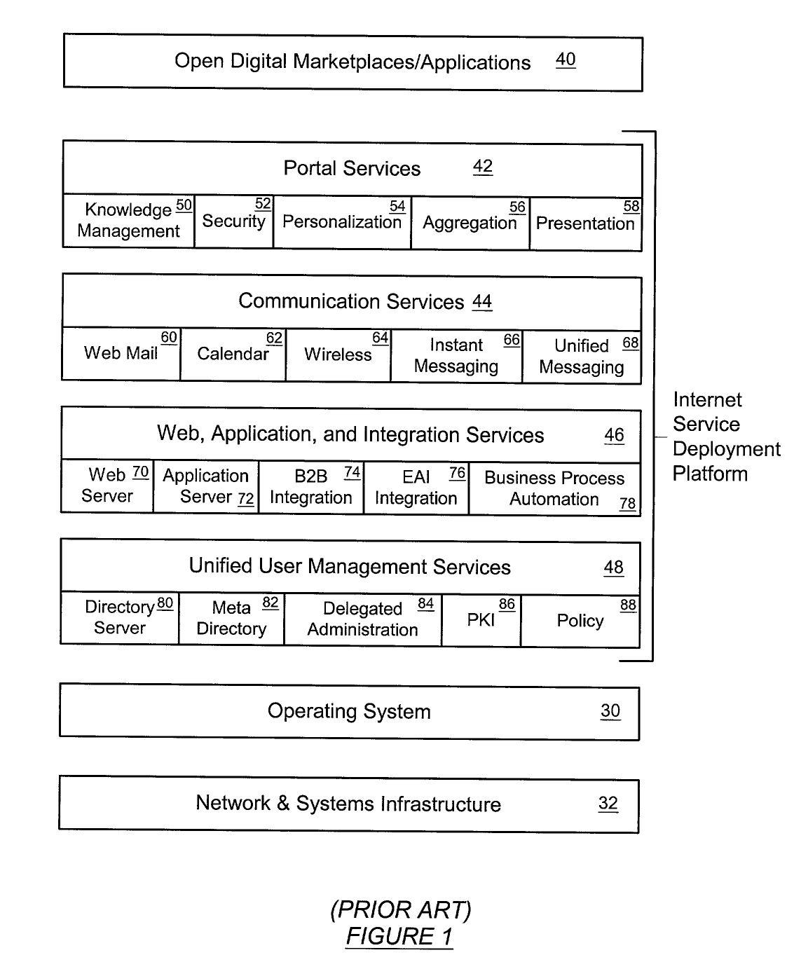

FIG. 2 illustrates part of a typical directory.

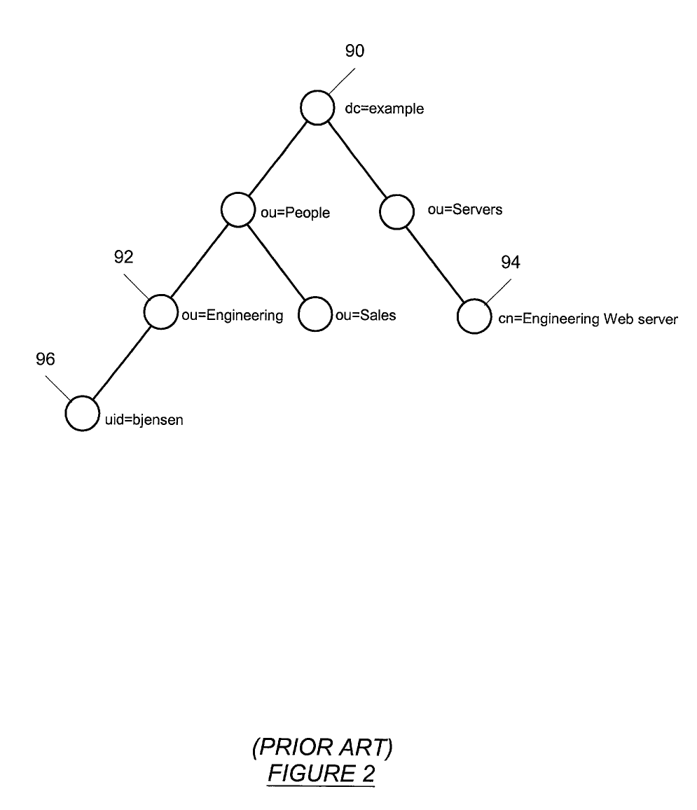

FIG. 3 illustrates the LDAP protocol used for a simple request.

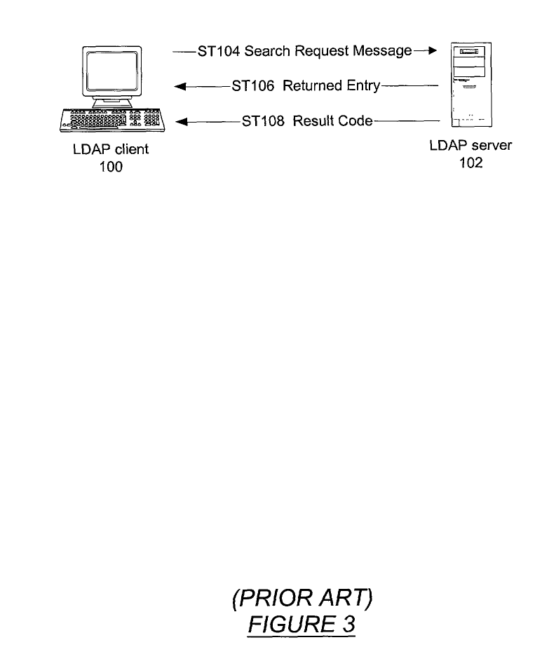

FIG. 4 illustrates a directory entry showing attribute types and values.

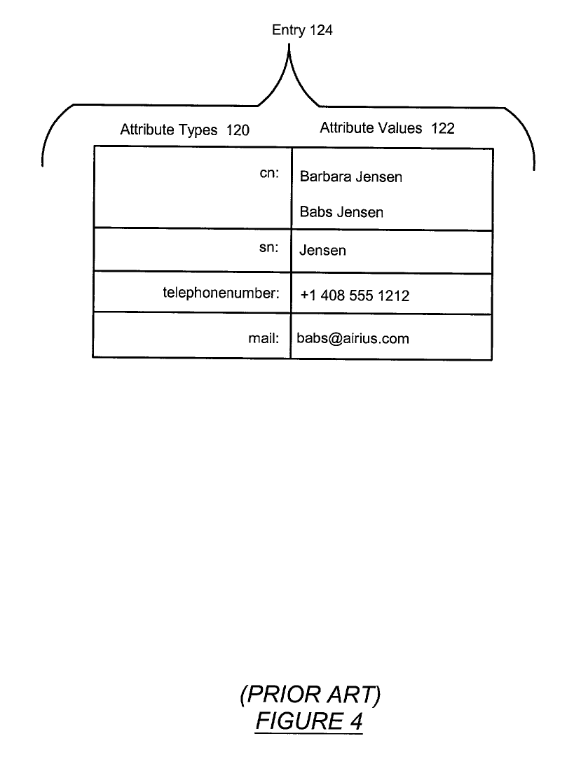

FIG. 5 illustrates a typical computer with components.

FIG. 6 illustrates access control lists stored in a directory information tree in accordance with one or more embodiments of the present invention.

FIG. 7 illustrates a sequence between a client and a server in accordance with one or more embodiments of the present invention.

### DETAILED DESCRIPTION

Specific embodiments of the invention will now be described in detail with reference to the accompanying figures. Like elements in the various figures are denoted by like reference numerals for consistency.

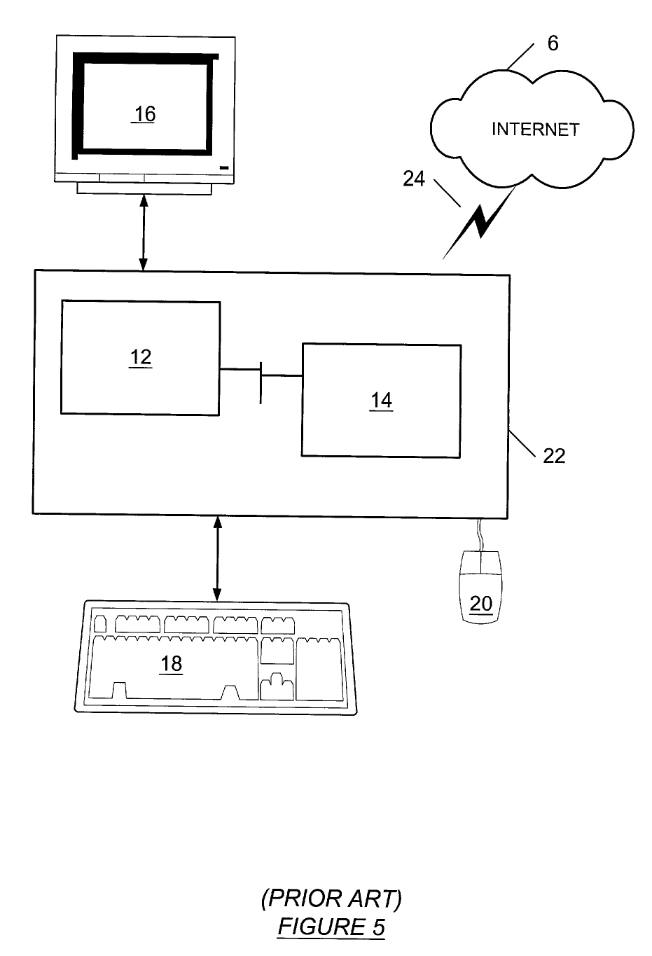

The invention described here may be implemented on virtually any type computer regardless of the traditional platform being used. For example, as shown in FIG. 5, a typical computer (22) has a processor (12), memory (14), among others. The computer (22) has associated therewith input means such as a keyboard (18) and a mouse (20), although in an accessible environment these input means may take other forms. The computer (22) is also associated with an output device such as a display (16), which also may take a different form in a given accessible environment. Computer (22) is connected via a connection means (24) to the Internet (6).

With the increase of computer systems and networks, along with the data stored on them, the demand on directory servers has increased dramatically. Directory servers are now expected to support massive directories, with potentially tens of millions of entries. Thus, managing those entries efficiently is important. Entry distribution in a directory server environment is a feature that allows a directory database to be distributed across multiple directory servers. This feature allows the directory server to “scale up” to support massive directories.

Entry distribution enables the deployment of a directory server mesh capable of storing at least tens of millions of entries. The directory performance is not degraded as a result of the function of the number of entries stored.

Four components of the iDS enable entry distribution, including multiple backends support, support for requests spanning over multiple backends, support for pluggable distribution methods, and a chaining backend. These four components can be used independently or, when used concurrently, allow entry distribution across a mesh of servers. Collectively, this is the LDAP multiplexer.

The chaining backend acts as the LDAP multiplexer and has no (or very limited) persistent storage capabilities. An instance of chaining backend is associated with a single remote server. Requests received by the chaining backend from an original client are forwarded to the remote server and results are returned to the original client.

Every standard LDAP operation is supported by the entry distribution method. Standard LDAP operations without any modifications are forwarded to the remote server when received by the chaining backend. Bind requests are chained to the remote server. An LDAP error code is returned that indicates whether a successful response is received from another server or not. In the face of “LDAP server down” or “LDAP connect failed” errors, up to a specified “tries” number of attempts are made to bind to the remote server. Attempts to bind to the remote server are retried without pause between attempts. The concern is to recover silently when the remote server is back up even though a decision had been made to close the connection. Both the maximum count of attempts and a bind timeout is configurable. Unbind operations are not chained to the remote server.

The chaining backend checks whether the operation is abandoned by examining the operation state using the plug-in API of the directory server. For single entry operations (every operation but one level or subtree-scoped searches), the operation state is checked when the operation result is received. For one-level or subtree-scoped search operations, the abandon operation is checked just before sending the search request, periodically (timeout in ldap_result()) checked while processing search results, and checked when receiving a search entry/search result.

The LDAP multiplexer may be configured so that a scoped search (one level or subtree) on a partitioned directory returns referrals that point to the remote servers holding entries instead of returning the entries directly. By default, entries are returned from the remote servers in accordance with one or more embodiments of the present invention.

The present invention involves supporting access control checks in a directory server with entry distribution using a chaining backend and distributing access control evaluation on a mesh of directory servers.

Access control checks within a directory service protect information contained in the directory. Access control specifies access to particular information by certain clients, while other clients have no access. When the server receives a request, the server uses the authentication information provided by the user in the bind operation, and the access control instructions (ACIs) defined in the server to allow or deny access to directory information. The level of permission granted to a user is dependent on the authentication information provided. The mechanism to specify control access is access control lists (ACLs). The directory ACLs include a series of one or more access control information (ACI) statements that either allow or deny permissions (e.g., read, write, search) and compare to specified entries and the attributes of the entries. Using the ACL, permissions may be set for the entire directory, a particular subtree of the directory, specific entries in the directory, a specific set of entry attributes, and any entry that matches a given LDAP search filter. In addition, permissions may be set for a specific user, all users belonging to a specific group, or for all users of the directory. Access may be defined as broadly a network location, such as an IP address or a Domain Name System (DNS) name.

ACIs are stored in the directory, as attributes of entries. The ACI attribute is an operational attribute, i.e., the attribute is available for use on every entry in the directory, regardless of whether defined for the object class of the entry. The ACI is used by the directory server to evaluate whether rights are granted or denied upon receipt of an LDAP request from a client. The three main parts of an ACI statement are a target, a permission, and a bind rule. The permission and bind rule portions of the ACI are set as a pair, also called an Access Control Rule (ACR). The specified permission is granted or denied based on whether the accompanying rule is evaluated to be true. Directory ACIs take the following general form: <target><permission><bind rule>.

The target specifies the directory element that the ACI applies, such as the entry (usually a subtree) to which the ACI is targeted, the attribute to which the ACI is targeted, or both. An ACI may target only one entry, but multiple attributes may be targeted. In addition, the target may contain an LDAP search filter that allows permissions to be set for widely scattered entries that contain common attribute values.

The permission identifies the actual permission being set by the ACI. The permission states that the ACI allows or denies a specific type of directory access, such as read or search, to the specified target.

The bind rule identifies the bind DN or network location to which the permission applies. The bind rule may also specify an LDAP filter. If the filter is evaluated to be true for the binding client application, then the ACI applies to the client application.

Taken together, ACIs are expressible as: “For the directory object <target>, allow or deny <permission> if the <bind rule> is true. The permission and bind rule are set as a pair, and multiple permission-bind rule pairs may exist for every target. This allows multiple access controls to be set efficiently for any given target. For example, a permission may be set to allow anyone binding as Babs Jensen to write to Babs Jensen's telephone number. The bind rule in this permission is the part that states, “if you bind as Babs Jensen.” The target is Babs Jensen's phone number, and the permission is write access.

If an entry in the directory server containing an ACI is a leaf entry, the ACI applies only to that entry. If the entry has entries below it, the ACI applies to the entry itself and all entries below it. As a direct consequence, when the server evaluates access permissions to any given entry, the ACIs for every entry between the one requested and the directory suffix is verified by the server, as well as the ACIs on the entry itself. The ACI attribute may be multi-valued meaning several ACIs can be defined for the same entry or subtree.

An ACI may be created on an entry that does not apply directly to that entry but to some or all of the entries in the subtree below the entry. The advantage of this feature is that a general ACI may be placed at a high level in the directory tree that effectively applies to entries more likely to be located lower in the directory tree. For example, at the level of an Organizational Unit (ou) entry or a locality entry, an ACI may be created that targets entries that include the inetorgperson object class. Therefore, this feature may be used to minimize the number of ACIs in the directory tree by placing general rules at high level branch points. To limit the scope of more specific rules, the rules should be placed as close as possible to leaf entries.

Evaluation of access rights to a particular entry, the server compiles a list of ACIs present on the entry itself and on the parent entries back up to the top level entry stored on the directory server. Traditionally, ACIs are evaluated across all databases for a particular directory server, but not across directory servers. Evaluation of the list of ACIs is done based on the semantics of the ACIs, not on placement in the directory tree. ACIs that are close to the root of the directory tree do not take precedence over ACIs that are closer to the leaves of the directory tree.

The most restrictive ACI in the ACI list takes precedence over less restrictive ACI. In the case of two contradictory statements where one allows access while the other denies access, the ACI that denies access takes precedence. For example, if write permission is denied at the directory's root level then none of the users can write to the directory regardless of the specific permissions your grant them. To grant a specific user write permissions to the directory, the scope of the original denial for the write permission restriction is changed so that the denial no longer includes the specific user.

Traditionally, ACIs apply to information that is typically stored on the same server. The evaluation of ACLs requires access to the user entry currently bound and to entries being accessed. In an entry distribution environment, where the directory tree is distributed over several servers using the chaining backend method, the user entry and the data entry are not necessarily co-located on the same server (but co-location may occur). ACLs that require access to the content of the user entry may not be supported when the user entry is not on the same server as the entries accessed. Thus, ACLs are difficult to evaluate and numerous restrictions apply, including keywords used in access control statements, ACLs based on roles or groups, etc.

In an entry distribution environment with a chaining backend method, an option for access control is to have the access control enforced by remote servers that hold the entries. Access control involves two distinct steps: authentication and authorization. Authentication is certifies the user (via the bind method in LDAP). Authorization determines the rights granted to that user.

Suppose the entry of a user U is stored in remote server A. U wants to access some data stored on another remote server B. The following is an example of an authentication phase of access control in accordance with one or more embodiments of the present invention. U binds to the LDAP multiplexer. The LDAP multiplexer forwards the authentication sequence (replays the bind operation, i.e. binds as U) to remote server A. If the bind succeeds, then U is authenticated from the LDAP multiplexer point of view as there is an implicit trust relationship between the LDAP multiplexer and the remote server holding the user entry. The following is an example of an authorization phase of access control in accordance with one or more embodiments of the present invention. Once U has been authenticated, the LDAP multiplexer binds as a “special” user to the remote server holding the target data. Then the LDAP multiplexer forwards the LDAP operation it received from U (e.g., LDAP search) during this connection along with the original user identity (U) by means of the proxy authentication control. The remote server evaluates the LDAP operation with U's rights instead of with the special user's rights.

The LDAP multiplexer bind as the end user to the remote server holding the requested entries. A bind succeeds for a simple bind if the user password is accessible by some means on the LDAP multiplexer. User ACLs are evaluated on the remote server with some restrictions. The LDAP multiplexer binds as a “special” user to the remote server (authentication identity) and tells the remote server to use the user identity (authorization identity) to perform the operation.

Multiple ways exist to convey the extra authorization identity to the remote server. A Proxied Authentication, SASL EXTERNAL, and DIGEST-MD5 authentication methods may define a way to convey authorization identity. The IP address, DNS domain, and the original authentication method may be passed along with the authorization identity. Support of impersonation requires configuration to specify the set of users (potentially a very large number) that a user can impersonate.

In an entry distribution environment with a chaining backend method, another option for access control is to evaluate ACLs on the LDAP multiplexer. The chaining backend method binds as a “special” user to the remote servers. Appropriate ACLS is configured on the LDAP multiplexer that has persistent storage capabilities. The LDAP multiplexer requires that both the user entry and the data entry are accessible. The user entry is required to be retrieved while data entry is required to be retrieved for delete/modify/compare/modrdn operations to evaluate ACLs.

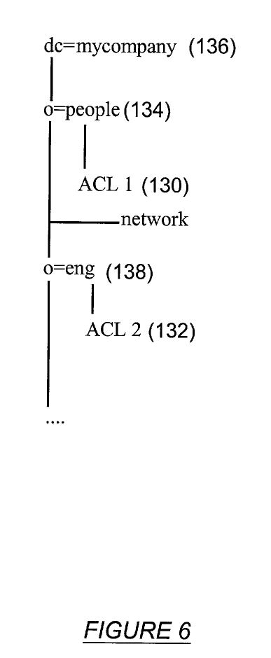

FIG. 6 illustrates ACLs defined on the LDAP multiplexer and ACLs defined on the remote server. ACLs are stored in a directory information tree (DIT) as special LDAP attributes so the ACLs may be retrieved using standard LDAP operations ACL 1 (130) defined in entry o=people (134) applies to the whole subtree of o=people (134), dc=mycompany (136. ACL 2 (132) defined in entry o=eng (138), o=people (134), dc=mycompany (136) applies to the whole subtree of o=eng (138, o=people (134), dc=mycompany (136). Unlike other LDAP operations, as a default behavior, operations performed by a chaining backend are typically not subject to the ACL defined on the LDAP multiplexer. A chaining backend can be configured to retrieve ACL 2 (132) and evaluate it on the LDAP multiplexer. ACL 1(130) is also evaluated on the LDAP multiplexer. When the chaining backend processes an LDAP operation, ACL 1 (130) and ACL 2 (132) can be evaluated on the LDAP multiplexer. If access is granted, the LDAP operation is forwarded to the remote server and ACL 2 (132) is evaluated (again).

The chaining backend can be configured to chain, i.e., process internal operations (LDAP operations issued by the LDAP server itself). By default, internal operations only returns entries local to a particular directory server. With this feature, internal operations can also grab entries stored on a remote server in a transparent way. The directory administrator can decide to have the access controls evaluated on the LDAP multiplexer as well, on a per chaining backend basis. However, ACLs are always enforced on the remote server, no matter how the LDAP multiplexer is configured. In one embodiment of the present invention, no need exists to duplicate ACLs on the LDAP multiplexer, remote ACLs defined “close” to the data are retrieved and evaluated on the LDAP multiplexer automatically.

User authentication requires access to the user entry to check credentials. In an entry distribution context, the LDAP multiplexer receives the bind request from the client. However, the user entry is usually held by a remote server. To resolve this issue in an entry distribution environment with a chaining backend method with an LDAP multiplexer, one option for authentication is use the multiplexer to forward the authentication sequence to the remote server holding the user entry.

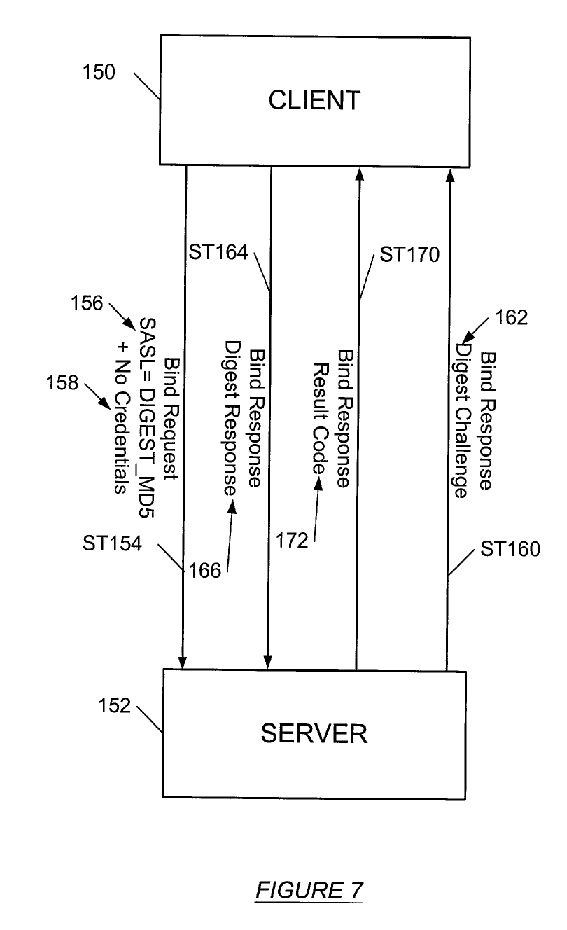

An example of an authentication sequence between a client (150) and a server (152) is shown in FIG. 7. First, the client (150) sends a bind request (Step 154) with the SASL mechanism equal to “DIGEST_MD5” (156) and no credentials (158). The server (152) responds with a bind response (Step 160) with a digest-challenge (162) including a realm, additional data, etc. The client (150) sends a bind response (Step 164) with a digest-response (166) including a username, the realm, a target host name, an authenticator, additional data, etc. The server (152) then sends back a bind response (Step 170) in which a result code (172) is either success or failure. While this authentication sequences is rather complex, a simple example is a “simple bind” that requires only two interactions between a client and a server. The client sends a bind request with credentials to the server. The server then sends a bind response (success or failure).

Using the DIGEST_MD5 authentication method, the LDAP multiplexer can forward the authentication sequence to the remote server if several conditions exist (unless a “simple bind” authentication is used). One condition is that the client may not interpret the realm value sent by the server in the digest-challenge. Another condition is that the server may not check the target host name field in the digest-response. Another condition is that the remote servers are part of the same realm.

A farm server chains an LDAP bind request received by the multiplexer in order to authenticate users whose entry is stored in a remote farm server used in conjunction with the pass-through authorization mechanism to convey the identity of the user, along with each LDAP requests so that access control can be enforced remotely on the remote server even if the entry of this user is not stored on that remote server.

Advantages of the present invention may include one or more of the following. Access control support is supported in a directory server using a chaining backend method. Users stored on a remote server can be authenticated. Data accessed through the LDAP multiplexer is protected. Those skilled in the art will appreciate that the present invention may have further advantages.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method to support access control checks in a directory server with a chaining backend, comprising:
binding a user to a multiplexer;
forwarding an authentication sequence from the multiplexer to a first remote server;
binding the user to the first remote server;
authenticating the user if binding to the first remote server is successful;
binding the multiplexer as a special user to a second remote server, wherein the second remote server holds target data;
sending an operation and an original user identity from the user to the multiplexer; and
forwarding the operation from the multiplexer to the second remote server.

2. The method of claim 1, further comprising:
retrieving an access control information statement from an access control list stored on the second remote server; and
evaluating the operation by the second remote server using the access control statement of the user.

3. The method of claim 2, wherein the access control information statement is stored as an attribute of an entry on the second remote server.

4. The method of claim 3, wherein the access control information statement comprises a target and an access control rule.

5. The method of claim 1, further comprising:
retrieving an access control information statement from an access control list stored on the multiplexer; and
evaluating the operation by the multiplexer using the access control statement of the user.

6. The method of claim 5, wherein the access control information statement is stored as an attribute of an entry on the multiplexer.

7. The method of claim 6, wherein the access control information statement comprises a target and an access control rule.

8. The method of claim 1, wherein forwarding the authentication sequence to the first remote server occurs when a realm value sent in a digest challenge is not interpreted by the directory server, a target host name field of a digest response is not checked by the directory server, and the first remote server is part of a common realm.

9. The method of claim 1, wherein the operation comprises an internal operation portion and an external operation portion.

10. The method of claim 9, further comprising:
chaining the internal operation portion based on an identity of a component issuing the internal operation.

11. The method of claim 2, further comprising:
enabling retrieval of the access control information statement on a remote server basis.

12. The method of claim 2, further comprising:
disabling retrieval of the access control information statement on a remote server basis.

13. The method of claim 6, further comprising:
retrieving the entry to evaluate an access control list on the multiplexer.

14. The method of claim 13, wherein the entry comprises a user.

15. The method of claim 13, wherein the entry comprises a group.

16. A computer system to support access control checks in a directory server with a chaining backend, comprising:
a processor;
a memory; and
software instructions stored in the memory for enabling the computer system under control of the processor, to perform:
binding a user to a multiplexer;
forwarding an authentication sequence from the multiplexer to a first remote server;
binding the user to the first remote server;
authenticating the user if binding to the first remote server is successful;
binding the multiplexer as a special user to a second remote server, wherein the second remote server holds target data;
sending an operation and an original user identity from the user to the multiplexer; and
forwarding the operation from the multiplexer to the second remote server.

17. The computer system of claim 16, wherein the software instructions further comprise instructions to perform:
retrieving an access control information statement from an access control list stored on the second remote server; and
evaluating the operation by the second remote server using the access control statement of the user.

18. The computer system of claim 16, wherein the software instructions further comprise instructions to perform:
retrieving an access control information statement from an access control list stored on the multiplexer; and
evaluating the operation by the multiplexer using the access control statement of the user.

19. An apparatus to support access control checks in a directory server with a chaining backend, comprising:
means for binding a user to a multiplexer;
means for forwarding an authentication sequence from the multiplexer to a first remote server;
means for binding the user to the first remote server;
means for authenticating the user if binding to the first remote server is successful;
means for binding the multiplexer as a special user to a second remote server, wherein the second remote server holds target data;
means for sending an operation and an original user identity from the user to the multiplexer; and
means for forwarding the operation from the multiplexer to the second remote server.

20. The apparatus of claim 19, further comprising:
means for retrieving an access control information statement from an access control list stored on the second remote server; and
means for evaluating the operation by the second remote server using the access control statement of the user.

21. The apparatus of claim 19, further comprising:
means for retrieving an access control information statement from an access control list stored on the multiplexer; and
means for evaluating the operation by the multiplexer using the access control statement of the user.
